(19) United States
(12) Patent Application Publication
(10) Pub. No.: US 2026/0036691 A1
(43) Pub. Date: Feb. 5, 2026

(54) System and Method for Temporal-Coherent Synthetic Aperture Radar Image Compression

(71) Applicant: AtomBeam Technologies Inc., Moraga, CA (US)

(72) Inventors: Zhu Li, Overland Park, KS (US); Paras Maharjan, Kansas City, MO (US)

(21) Appl. No.: 19/302,277

(22) Filed: Aug. 18, 2025

Related U.S. Application Data
(63) Continuation-in-part of application No. 18/792,542, filed on Aug. 1, 2024, now Pat. No. 12,392,891.

(51) Int. Cl. G01S 13/90; H04N 19/124; H04N 19/13; H04N 19/136; H04N 19/142; H04N 19/154; H04N 19/172; H04N 19/182; H04N 19/625

(52) U.S. Cl. CPC G01S 13/9021; G01S 13/9017; H04N 19/124; H04N 19/13; H04N 19/136; H04N 19/172; H04N 19/182; H04N 19/625; H04N 19/142; H04N 19/154

(57) ABSTRACT

A system and method for compressing temporal stacks of synthetic aperture radar (SAR) images while preserving interferometric properties. The system receives multiple SAR images acquired over time, aligns them through coregistration, and maintains phase continuity across the temporal sequence. A three-dimensional discrete cosine transform processes both spatial and temporal dimensions, creating hybrid subbands organized by frequency content and temporal change characteristics. The system employs a change-aware encoder that selectively uses differential encoding for small changes between frames and full encoding at adaptive keyframe intervals. A temporal coherence network with separate pathways for amplitude and phase information ensures consistency across the image stack. The compressed output preserves interferometric coherence properties essential for applications such as ground deformation monitoring and change detection. The system achieves compression ratios from 10:1 to 50:1 for static content while maintaining higher quality for rapidly changing features.

### CROSS-REFERENCE TO RELATED APPLICATIONS

Priority is claimed in the application data sheet to the following patents or patent applications, each of which is expressly incorporated herein by reference in its entirety:
Ser. No. 18/792,542

### BACKGROUND OF THE INVENTION

### Field of the Art

The present invention is in the field of data processing, and more particularly is directed to the problem of compressing synthetic aperture radar images, including temporal stacks of such images.

### Discussion of the State of the Art

Synthetic aperture radar (SAR) is a form of radar technology that is used to create high-resolution images of landscapes. Unlike traditional radar systems, which rely on a large physical antenna, SAR uses the motion of the radar platform (such as an aircraft or satellite) to simulate a much larger antenna, or “synthetic aperture.” This allows SAR to achieve much higher resolution images than conventional radar. SAR can operate in any weather conditions and during both day and night because it relies on microwave radiation, which can penetrate clouds and is independent of sunlight. Additionally, SAR can penetrate certain materials like vegetation, ice, and snow, allowing it to image objects or features hidden beneath these materials.

Modern SAR systems increasingly acquire multiple images of the same area over time to enable advanced applications such as interferometric SAR (InSAR) for ground deformation monitoring, coherent change detection for identifying subtle surface changes, and time-series analysis for environmental monitoring. These temporal stacks of SAR images can contain dozens or even hundreds of acquisitions over months or years, creating massive data volumes. For example, satellite missions like Sentinel-1 acquire SAR images of the same location every 6-12 days, rapidly accumulating temporal datasets that can exceed terabytes for even modest areas of interest.

Current SAR compression techniques primarily focus on compressing individual SAR images without considering the significant temporal redundancy present in multi-temporal SAR stacks. When compressing temporal sequences, existing methods either compress each image independently, failing to exploit temporal correlations, or apply video compression techniques that were designed for natural imagery and fail to preserve the phase information critical for interferometric applications. This results in either poor compression ratios when treating each image independently, or loss of interferometric coherence when using conventional video codecs. Furthermore, existing approaches do not differentiate between static infrastructure that remains unchanged across acquisitions and dynamic features that require careful preservation, leading to inefficient bit allocation.

What is needed is a compression system specifically designed for temporal stacks of SAR images that exploits temporal redundancy while preserving interferometric properties, adapts compression strategies based on temporal change characteristics, and maintains phase coherence across the temporal sequence to enable advanced SAR applications such as InSAR and coherent change detection.

### SUMMARY OF THE INVENTION

The inventor has conceived and reduced to practice a system and method for compressing temporal stacks of synthetic aperture radar (SAR) images while preserving their interferometric properties critical for applications such as ground deformation monitoring, change detection, and environmental surveillance. The system extends traditional single-frame SAR compression to efficiently process multiple SAR images acquired over time by exploiting temporal redundancy while maintaining phase coherence across the image sequence. The system performs three-dimensional compression across both spatial and temporal dimensions, intelligently differentiating between static content that can be heavily compressed and dynamic content requiring higher fidelity. By implementing separate processing pathways for amplitude and phase information with cross-attention mechanisms, the system ensures that interferometric relationships between temporal acquisitions are preserved.

In an embodiment, a computer system comprising a hardware memory is configured to execute software instructions that receive a temporal stack of N synthetic aperture radar (SAR) images, where each SAR image includes in-phase and quadrature components. The system performs temporal preprocessing including coregistration for sub-pixel alignment and phase history tracking to maintain phase continuity. A three-dimensional discrete cosine transform operates across spatial and temporal dimensions to create temporal-spatial subbands organized into hybrid groups of spatial subbands (first low frequency, second low frequency, and high frequency groups) and temporal subbands (static, slow-change, and fast-change groups). The system implements a change-aware latent space encoder with a reference frame selector identifying frames with median temporal characteristics, a differential encoding branch for temporal changes, and an absolute encoding branch for keyframe intervals. Temporally-coherent latent space representations are generated using a temporal coherence network processing amplitude and phase through separate pathways with cross-attention mechanisms. Finally, arithmetic coding creates a compressed bitstream preserving interferometric coherence properties.

In an aspect of an embodiment, the system implements an interferometric preservation engine that identifies phase unwrapping boundaries and adjusts quantization parameters near these boundaries to preserve interferometric properties.

In an aspect of an embodiment, the system implements a multi-scale temporal context model hierarchically processing frame-level, sequence-level, and scene-level contexts, with each scale progressively refining the previous scale's context.

In an aspect of an embodiment, the system applies variable compression ratios: 10:1 to 50:1 for static subband groups, 5:1 to 20:1 for slow-change subband groups, and 2:1 to 10:1 for fast-change subband groups.

In an aspect of an embodiment, the temporal coherence network implements a coherence loss function jointly optimizing amplitude consistency, phase relationships, and interferometric coherence between frame pairs.

In an aspect of an embodiment, the change-aware latent space encoder monitors change magnitude between frames and adaptively routes frames to either differential or absolute encoding branches based on threshold comparison.

In an aspect of an embodiment, the system generates a progressive bitstream structure enabling partial decoding from change masks through full phase-preserving interferometric data across four levels.

In an aspect of an embodiment, temporal preprocessing includes a temporal radiometric normalizer compensating for varying acquisition conditions to establish a common radiometric reference.

In an aspect of an embodiment, the temporal coherence network comprises bidirectional temporal processing networks with separate amplitude and phase pathways connected through cross-attention mechanisms.

In an aspect of an embodiment, the interferometric preservation engine separates atmospheric phase effects from ground phase information for independent compression of these components.

In an embodiment, a method for temporal-coherent synthetic aperture radar image compression receives a temporal stack of N SAR images with in-phase and quadrature components. The method performs temporal preprocessing including coregistration and phase history tracking, executes three-dimensional discrete cosine transform operations creating hybrid temporal-spatial subband groups, implements change-aware latent space encoding with reference frame selection and dual encoding branches, generates temporally-coherent latent representations using separate amplitude and phase pathways, and performs arithmetic coding to create a compressed bitstream preserving interferometric coherence properties.

### BRIEF DESCRIPTION OF THE DRAWING FIGURES

FIG. 1 is a block diagram illustrating an exemplary system architecture for compressing synthetic aperture radar (SAR) images, according to an embodiment.

FIG. 2 is a block diagram showing details of SAR subbands, according to an embodiment.

FIG. 3 is a block diagram illustrating details for subband-wise learning-based SAR image compression, according to an embodiment.

FIG. 4 illustrates formulas that may be used in an embodiment.

FIG. 5 is a flow diagram illustrating an exemplary method for compressing SAR image data, according to an embodiment.

FIG. 6 is a flow diagram illustrating an exemplary method for training a system for compressing and restoring telemetry data, according to an embodiment.

FIG. 7 is a block diagram illustrating an exemplary system architecture for temporal-coherent synthetic aperture radar (SAR) image compression, showing data flow from temporal stack preprocessing through temporal coherence modeling, context refinement, interferometric preservation, and subband-specific compression.

FIG. 8 is a block diagram illustrating temporal-spatial subband decomposition within the SAR compression system, including three-dimensional discrete cosine transform processing and classification of hybrid subbands by spatial frequency and temporal variability for targeted compression strategies.

FIG. 9 is a flow diagram illustrating the operation of the change-aware latent space encoder and temporal coherence network, including reference frame selection, adaptive encoding pathway switching, and bidirectional temporal processing for amplitude and phase components.

FIG. 10 is a flow diagram illustrating a method for temporal-coherent SAR image compression, from temporal stack reception and preprocessing through hybrid subband transformation, change-aware encoding, temporal modeling, interferometric optimization, and progressive bitstream generation.

FIG. 11 illustrates an exemplary computing environment on which an embodiment described herein may be implemented, in full or in part.

The drawings are not necessarily to scale. The drawings are merely schematic representations, not intended to portray specific parameters of the disclosed embodiments. The drawings are intended to depict only typical embodiments of the invention, and therefore should not be considered as limiting in scope.

### DETAILED DESCRIPTION OF THE INVENTION

Managing temporal sequences of SAR images presents significant challenges beyond those encountered with single image compression. Satellite constellations and persistent monitoring systems now routinely acquire SAR images of the same geographic areas at regular intervals, creating temporal stacks that can contain hundreds of acquisitions. For instance, a year-long monitoring campaign with bi-weekly acquisitions generates over 25 images per location, and when multiplied across multiple polarizations and viewing geometries, the data volume becomes prohibitive for transmission and storage. The temporal dimension introduces both opportunities and complexities: while successive images often contain substantial redundancy that could enable high compression ratios, the phase relationships between acquisitions must be preserved to enable interferometric applications that are central to modern SAR analysis.

Disclosed embodiments address these challenges through a temporal-coherent compression system that extends single-frame SAR compression capabilities to efficiently process temporal stacks while preserving interferometric properties. The system recognizes that different aspects of SAR imagery evolve at different rates over time; infrastructure and terrain typically remain static, vegetation undergoes seasonal changes, and human activities create rapid localized changes. By decomposing temporal stacks into spatial-temporal subbands and applying adapted compression strategies to each category, the system achieves compression ratios ranging from 10:1 to 50:1 for static content while maintaining fidelity for dynamic features.

At the input stage, the system receives a temporal stack comprising N SAR images, where each image contains complex-valued data represented as in-phase (I) and quadrature (Q) components. The value of N may range from as few as 2 images for basic change detection to hundreds of images for long-term monitoring applications. Each image in the stack maintains the complex number format that captures both amplitude and phase information essential for SAR applications.

A temporal preprocessing stage prepares the image stack for compression by addressing the geometric and radiometric variations that naturally occur across multiple acquisitions. A coregistration subsystem achieves sub-pixel alignment between images using a combination of orbital metadata and image matching techniques. This alignment is critical because even small misregistrations can destroy interferometric coherence. In one embodiment, the coregistration employs a coarse-to-fine approach, first using orbital parameters to achieve pixel-level alignment, then refining with normalized cross-correlation or phase correlation methods to achieve sub-pixel precision.

A phase history tracker within the preprocessing stage maintains phase continuity across temporal acquisitions. SAR phase measurements are inherently ambiguous, wrapping every 2×radians, and this ambiguity must be carefully managed across time to preserve interferometric relationships. The phase history tracker identifies and corrects phase jumps between consecutive acquisitions while maintaining a consistent phase reference throughout the stack. A temporal radiometric normalizer compensates for variations in radar backscatter that arise from different acquisition conditions, such as changes in incidence angle or system calibration drift over time.

Following preprocessing, the system performs three-dimensional discrete cosine transform (3D-DCT) operations that extend the spatial DCT of single-image compression into the temporal dimension. Rather than processing each image independently with 2D-DCT, the system applies DCT across spatial blocks and temporal windows simultaneously. For example, spatial blocks of 8×8 pixels may be combined with temporal blocks of 4-8 consecutive frames to create 3D processing units. This three-dimensional transformation reveals temporal-spatial frequency components that can be efficiently compressed based on their information content.

The 3D-DCT operation produces temporal-spatial subbands that are organized into hybrid groups reflecting both spatial frequency content and temporal variability. Spatial organization follows established patterns with low frequency groups (LF1 and LF2) containing the bulk of image energy and high frequency groups (HF) containing fine details. The temporal dimension introduces additional categorization: static subbands (TS) contain near-zero temporal frequency components representing unchanging features, slow-change subbands (TSC) capture gradual variations such as seasonal vegetation changes, and fast-change subbands (TFC) represent rapid modifications such as vehicle movements or construction activities.

A change-aware latent space encoder processes these temporal-spatial subbands using strategies adapted to their content. A reference frame selector analyzes the temporal stack to identify frames with median temporal characteristics, providing stable reference points for differential encoding. The selection process may consider factors such as image quality, atmospheric conditions, and temporal position within the stack. Rather than always using the first or last frame as a reference, the system adaptively chooses references that minimize overall encoding cost.

The encoder implements dual processing pathways to balance compression efficiency with reconstruction quality. A differential encoding branch computes and encodes only the changes between frames and their references, dramatically reducing data volume for slowly changing scenes. When processing frame differences, the encoder may apply techniques such as motion compensation to account for systematic shifts or predictable changes. An absolute encoding branch provides full encoding of selected keyframes, ensuring that compression errors do not accumulate indefinitely and providing random access points within the compressed stream.

Switching logic within the encoder monitors change magnitudes and characteristics to route each frame or region to the appropriate encoding pathway. The switching decision may be made at multiple granularities; entire frames may be designated as keyframes when global changes exceed thresholds, while local regions within frames may independently switch between differential and absolute encoding based on local change characteristics. This adaptive approach ensures that static regions achieve maximum compression while preserving full fidelity for areas of significant change.

A temporal coherence network processes the encoded representations to ensure consistency across the temporal dimension. The network architecture employs separate processing pathways for amplitude and phase information, recognizing that these components have different statistical properties and quality requirements. Amplitude information, representing radar backscatter intensity, can often tolerate some degradation without impacting analysis. Phase information, however, must be preserved with high fidelity to maintain interferometric coherence.

In one embodiment, the temporal coherence network utilizes bidirectional processing architectures such as bidirectional long short-term memory (LSTM) networks or transformer architectures with temporal attention mechanisms. Forward processing captures causal relationships where past frames influence future predictions, while backward processing leverages future frames to refine estimates of earlier time points. The bidirectional approach is particularly effective for applications where the entire temporal stack is available before compression, such as archival or batch processing scenarios.

Cross-attention mechanisms within the temporal coherence network enable information exchange between amplitude and phase pathways. While processed separately to accommodate their different characteristics, amplitude and phase are not independent; strong amplitude returns typically correspond to stable phase centers, while low amplitude regions may exhibit phase noise. The cross-attention mechanism allows each pathway to inform the other, improving overall compression quality.

A multi-scale temporal context model captures temporal relationships at different time scales. Frame-level context examines immediate temporal neighbors to capture short-term variations and ensure smooth transitions. Sequence-level context considers broader temporal windows to identify periodic patterns such as seasonal variations or regular human activities. Scene-level context maintains information about persistent features that remain constant across the entire temporal stack, enabling efficient reuse of static information.

An interferometric preservation engine specifically addresses the requirements of interferometric SAR applications. Phase unwrapping boundaries, where phase differences approach ±π, require careful handling to prevent artifacts. The engine identifies these critical regions and adjusts quantization parameters to maintain phase continuity. For SAR interferometry, even small phase errors near unwrapping boundaries can propagate through the unwrapping process, corrupting large areas of the interferogram.

The interferometric preservation engine also addresses baseline-dependent effects. Interferometric processing combines SAR images acquired from slightly different orbital positions, with the spatial separation (baseline) determining the sensitivity to topography and deformation. Image pairs with longer baselines require higher phase precision to maintain coherence. The engine adapts compression parameters based on the baseline configuration of potential interferometric pairs within the stack.

Atmospheric phase effects present another challenge for temporal SAR compression. The atmosphere introduces phase delays that vary with weather conditions, creating phase patterns that change between acquisitions but do not represent ground motion. The interferometric preservation engine may separate atmospheric phase screens from ground phase, enabling more efficient compression by encoding slowly varying atmospheric patterns separately from ground features.

The system implements differentiated compression strategies based on temporal-spatial subband characteristics. Static subbands, containing unchanging infrastructure and terrain, may achieve compression ratios between 10:1 and 50:1 through aggressive quantization and efficient entropy coding. These subbands are encoded once and reused across all frames, dramatically reducing data volume for static scene components. Slow-change subbands employ moderate compression ratios between 5:1 and 20:1, updating at reduced temporal rates to capture gradual evolution while maintaining efficiency. Fast-change subbands receive the highest bit allocation with compression ratios between 2:1 and 10:1, preserving full temporal resolution for rapidly evolving features.

An arithmetic coding subsystem performs final entropy coding of the compressed representations. The arithmetic coder adapts its probability models based on temporal context, recognizing that later frames in a sequence can be coded more efficiently as the statistical model refines. Separate probability models may be maintained for different subband types, optimizing compression for the specific characteristics of static, slow-change, and fast-change content.

The output bitstream is structured to support progressive decoding and partial reconstruction. A header section contains temporal metadata including frame count, timestamps, reference frame indices, and keyframe locations. The bitstream body is organized in progressive levels: a first level enables reconstruction of change masks indicating where temporal changes occur, a second level provides change magnitudes and characteristics, a third level enables full amplitude reconstruction, and a fourth level includes phase information for interferometric processing. This progressive structure allows applications to decode only the information needed for their specific analysis tasks.

The system architecture is designed for efficient hardware implementation across various platforms. Spatial parallelism allows multiple spatial blocks to be processed simultaneously across GPU cores or FPGA processing elements. Temporal parallelism enables pipeline processing where different frames are at different stages of compression simultaneously. Subband parallelism assigns different processors to different temporal-spatial subband types, exploiting their different computational requirements. Memory access patterns are optimized for cache efficiency and streaming processing, critical for high-throughput implementations.

The temporal-coherent compression system maintains compatibility with existing single-frame SAR compression infrastructure while adding temporal capabilities. Legacy systems expecting single compressed SAR images can access individual frames through keyframe extraction. The progressive bitstream structure allows graceful degradation where systems with limited processing capability can reconstruct basic change information without full decompression. Standard SAR processing tools can work with decompressed temporal stacks without modification, as the system preserves the complex-valued SAR data format throughout the compression-decompression cycle.

In some embodiments, the change-aware latent space encoder may incorporate predictive coding mechanisms that utilize motion compensation to better handle dynamic scene elements such as moving vehicles, flooding, or urban activity. Motion vectors may be estimated between frames and used to align features before differential encoding, reducing temporal noise and improving compression efficiency. This approach enables the system to differentiate between stationary and non-stationary components more effectively and may be combined with adaptive residual coding to preserve fidelity in high-motion regions.

In further embodiments, additional system enhancements may include semantic change classification modules that analyze detected changes across frames and assign semantic categories such as vegetation growth, infrastructure development, or surface water expansion. The system may adjust compression parameters dynamically based on the identified change type, allocating more bits to semantically significant regions. The system architecture may also support parallel hardware acceleration, including assignment of temporal-spatial subbands to independent GPU threads or FPGA cores for high-throughput processing. Additionally, training of the temporal coherence network may be guided by a multi-objective loss function that jointly optimizes amplitude reconstruction, phase continuity, interferometric coherence, and change detection accuracy.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing subsystems, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “synthetic aperture radar” refers to an active remote sensing technique that combines data from multiple shorter acquisitions to simulate a larger antenna.

The term “neural network” refers to a computer system modeled after the network of neurons found in a human brain. The neural network is composed of interconnected nodes, called artificial neurons or units, that work together to process complex information.

The term “bitstream” refers to a binary sequence of data representing the compressed version of input data.

The term “autoencoder” refers to a type of neural network architecture that can learn compact representations of data.

The term “temporal stack” refers to a sequence of synthetic aperture radar (SAR) images acquired over time, typically under similar geometric and radiometric conditions, forming a time-series dataset suitable for temporal analysis, interferometric processing, or change detection.

The term “hybrid subband” refers to a data group resulting from the combination of a spatial frequency classification (such as LF1, LF2, or HF) and a temporal variability category (such as TS, TSC, or TFC), representing signal behavior across both spatial and temporal dimensions.

The term “reference frame” refers to a SAR image within a temporal stack selected as a baseline for differential encoding, commonly chosen based on temporal median characteristics or encoding cost optimization to enhance compression efficiency and reconstruction fidelity.

### Conceptual Architecture

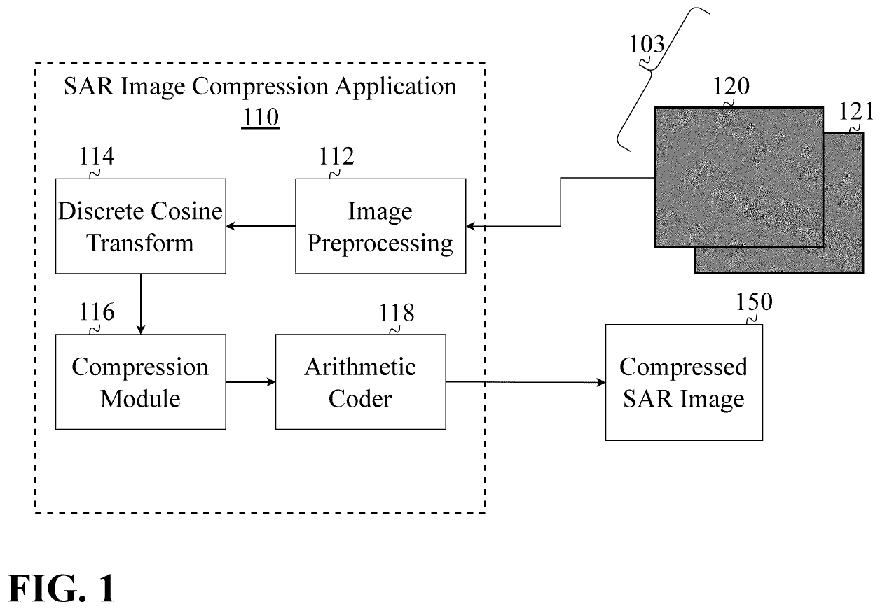

FIG. 1 is a block diagram illustrating an exemplary system architecture for compressing synthetic aperture radar (SAR) images, according to an embodiment. A SAR image 103 is input to the SAR image compression application 110. The SAR image 103 can include a first component 120 and a second component 121. In embodiments, the first component 120 comprises an amplitude component and the second component 121 comprises a phase component. The amplitude refers to the magnitude or strength of a signal. It can be represented as the absolute value of a complex signal. The phase represents the timing or position of the signal relative to a reference. In embodiments, the phase may be represented in units of degrees or radians. In one or more embodiments, the first component 120 comprises an in-phase (I) component, and the second component 121 comprises a quadrature (Q) component. The in-phase component represents the real part of a complex signal. The in-phase component corresponds to the amplitude of the signal when it is in phase with a reference. The quadrature component represents the imaginary part of the complex signal. The quadrature component corresponds to the amplitude of the signal when it is 90 degrees out of phase with the reference.

In one or more embodiments, one, or both of the components may be processed by the SAR image compression application 110. The SAR image compression application 110 can include an image preprocessing subsystem 112. The image processing subsystem can perform one or more operations on the first component 120 and/or second component 121. The preprocessing can include a radiometric calibration process to correct the SAR image for sensor-specific biases and noise, ensuring that the pixel values accurately represent the radar backscatter of the surface. The preprocessing can include a geometric calibration process to correct geometric distortions caused by the motion of the SAR imaging sensor and the Earth's curvature. The preprocessing can include noise reduction. The noise reduction can include speckle filtering to reduce speckle noise, which may be present in acquired SAR images due to the coherent nature of radar signals. In one or more embodiments, techniques including a Lee filter, Frost filter, and/or Gamma MAP filter may be used for the speckle filtering. The noise reduction can include median filtering to reduce noise while preserving edges and fine details. The preprocessing can include contrast enhancement to improve the visibility of features. In one or more embodiments, techniques including, but not limited to, histogram equalization and adaptive contrast enhancement are used to perform contrast enhancement. The preprocessing can include edge enhancement. In one or more embodiments, the edge enhancement can be implemented with techniques including, but not limited to, Sobel and/or Canny edge detectors. The preprocessing can include geocoding and/or georeferencing. The geocoding can include converting the SAR image coordinates to a standard map projection, aligning it with geographical coordinates. The georeferencing can include aligning the SAR image with a geographic coordinate system using ground control points (GCPs). Other preprocessing techniques may be used instead of, or in addition to, the aforementioned preprocessing operations.

The preprocessed image data is input to discrete cosine transform (DCT) subsystem 114. The Discrete Cosine Transform (DCT) is a mathematical technique well-suited for signal and image processing. The DCT represents an image as a sum of sinusoids with varying magnitudes and frequencies. The discrete cosine transform subsystem 114 is configured to compute the two-dimensional DCT of an image, capturing essential features. In embodiments, the input image is divided into blocks (e.g., 8-by-8 or 16-by-16), and a DCT is computed for each block, yielding coefficients that are used as part of the compression/decompression process. In embodiments, the discrete cosine transform subsystem 114 comprises programming instructions that when operating on the processor, cause the processor to perform a DCT operation on the quadrature component of the input SAR image, and create a second plurality of subbands for the quadrature component of the input SAR image.

The output of the discrete cosine transform (DCT) subsystem 114 is input to the compression subsystem 116. The compression subsystem 116 is configured to implement a latent feature learning block, wherein the latent feature learning block is configured and disposed to generate a latent space representation corresponding to the multiple groups of subbands. The compression subsystem may perform pixel unshuffling on the output of the discrete cosine transform (DCT) subsystem 114 to create one or more subbands. In embodiments, the subbands include a DC subband, and one or more AC subbands, where each AC subband represents a frequency range. In embodiments, a DC subband and 15 AC subbands are used, for a total of 16 subbands (i.e., 16 channels).

The compression subsystem 116 may further perform subband grouping. The subband grouping can include grouping subbands into a high frequency (HF) group, and one or more low frequency (LF) groups. In embodiments, the compression subsystem 116 groups the subbands into two low frequency groups (LF1, and LF2), and a high frequency group (HF). In one or more embodiments, one or more subbands may be discarded. In embodiments, the discarding includes discarding one or more subbands in the high frequency group, as those subbands often do not contain large amounts of meaningful information that is beneficial for SAR image analysis. Accordingly, discarding one or more subbands can help improve the compression ratio of SAR images. The compression subsystem 116 may further include a neural network to process each subband individually. The neural network can include an autoencoder, an implicit neural representation (INR), a deep learning neural network, and/or other suitable neural network. In embodiments, the compression subsystem 116 comprises programming instructions that when operating on the processor, cause the processor to discard one or more subbands prior to generating the latent space representation. In embodiments, the compression subsystem 116 further comprises programming instructions that when operating on the processor, cause the processor to implement a context network, wherein the context network is configured to compute a thumbnail version of the latent space representation. In embodiments, the compression subsystem further comprises programming instructions that when operating on the processor, cause the processor to implement a multi-stage context recovery subsystem, wherein the multi-stage context recovery subsystem comprises a first loss function associated with the first low frequency group, a second loss function associated with the second low frequency group, and a third loss function associated with the high frequency group. In embodiments, at least one of the first loss function, second loss function, and third loss function is based on a weighting scheme. In embodiments, at least one of the first loss function, second loss function, and third loss function is optimized for amplitude recovery. In embodiments, at least one of the first loss function, second loss function, and third loss function is optimized for phase recovery.

The output of the compression subsystem 116 can be input to arithmetic coder subsystem 118. In embodiments, the arithmetic coder subsystem 118 is configured to represent a string of characters using a single fractional number between 0.0 and 1.0. Frequently occurring symbols are stored with fewer bits, while rare symbols use more bits. In one or more embodiments, the arithmetic coder subsystem 118 can implement adaptive arithmetic coding, in which case the arithmetic coder subsystem 118 adapts to changing probabilities during the encoding process. The output of the arithmetic coder subsystem 118 can serve as a compressed SAR image 150. A compressed SAR image such as compressed SAR image 150 can be efficiently transmitted from a satellite or aircraft to a ground station, where it can then be decompressed using corresponding decompression techniques.

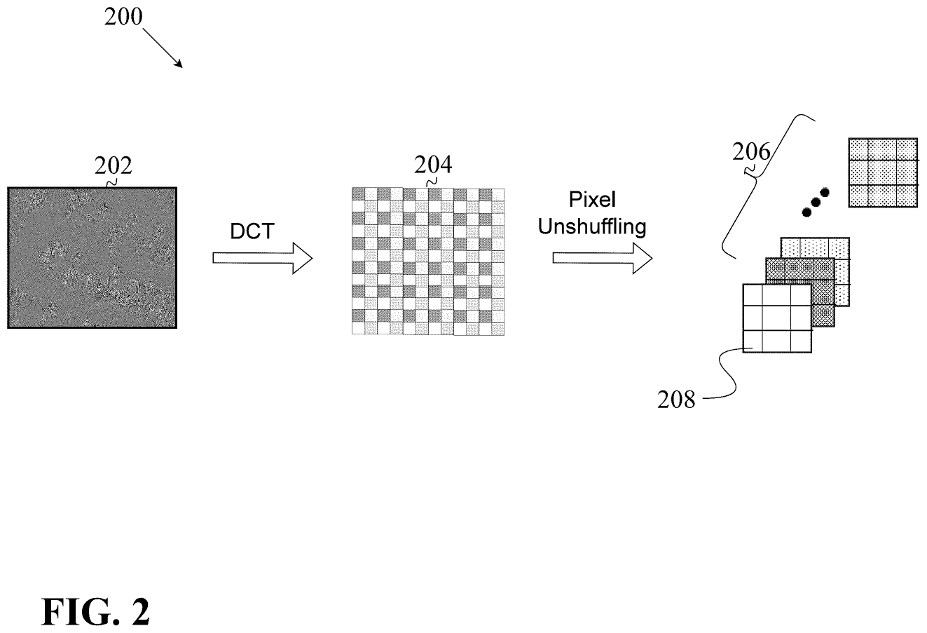

FIG. 2 is a block diagram 200 showing details of SAR subbands, according to an embodiment. In the diagram 200, an input SAR image 202 has a DCT process performed on it to create a DCT representation 204. The DCT representation 204 then may have a pixel unshuffling process performed on it, to create subband array 206, which includes multiple AC subbands, each representing a range of frequencies, and a DC subband, indicated as 208. The DCT representation 204 includes a set of coefficients that represent the frequency components of the input SAR image 202. These coefficients capture information about the image's spatial frequencies and help compress it efficiently. When the input SAR image 202 is divided into blocks (e.g., 8×8 or 16×16), each block undergoes DCT. The DCT coefficients may initially be arranged in a zigzag pattern within the block. Pixel unshuffling rearranges these coefficients into a linear order. This linear order facilitates efficient storage and transmission of the compressed data. In embodiments, the linear order is one of row-major or column-major.

In one or more embodiments, the SAR image 202 may be stored in a format such as GeoTIFF. The GeoTIFF format embeds georeferencing information within the image file, allowing the SAR data to be easily aligned with geographic coordinates. Other formats for storing/representing the SAR image 202 may include, but are not limited to, Hierarchical Data Format 5 (HDF5), CEOS (Committee on Earth Observation Satellites), NITF (National Imagery Transmission Format), and/or other suitable formats. The SAR data, stored in one of the aforementioned formats, and/or other suitable format, may be stored in a complex format, in which each pixel contains a complex number in the form of: (I+jQ). The real part of the complex data represents the In-phase component (I), and the imaginary part of the complex data represents the Quadrature component (Q). Tools such as Python along with the GDAL (Geospatial Data Abstraction Library) library, can be used to read a SAR image. A mathematical package such as NumPy may be used to extract the real and/or imaginary parts of the SAR image for data compression. Computations including magnitude and phase calculations may be performed in parallel on one or more subbands, thereby enabling efficient implementation on multi-core and/or multi-processor hardware.

Disclosed embodiments can utilize different neural networks to learn efficient latent representations of the subbands, with their own loss function that is adaptive to the subsequent recovery tasks, i.e., for amplitude or phase recovery. Embodiments can include using a different loss function and training strategy on a subband basis, or a subband group basis. Embodiments can include an 8×8 block wise decomposition, comprising multiple groups of subbands. In embodiments, there are three groups of subbands. In embodiments, a first group (Group 1) includes sorted index from 1 to 36, including predominantly DC and low frequency information, and thus, can be referred to as a Low Frequency (LF) group, while group 2 can include a sorted channel index from 37 to 48, that includes mainly higher frequency info for which is referred to as High Frequency (HF) group, while the third group for the remaining channels, are mainly imaging noise for which can be discarded to further improve compression efficiency. With this decomposition, instead of compression SAR images of H×W×2 resolution, the resulting output includes subbands of (H/8)×(W/8)×2 images that have more intra-group statistical similarity for effective learning. Furthermore, the loss function can be optimized subband wise, to different tasks like amplitude vs phase recovery.

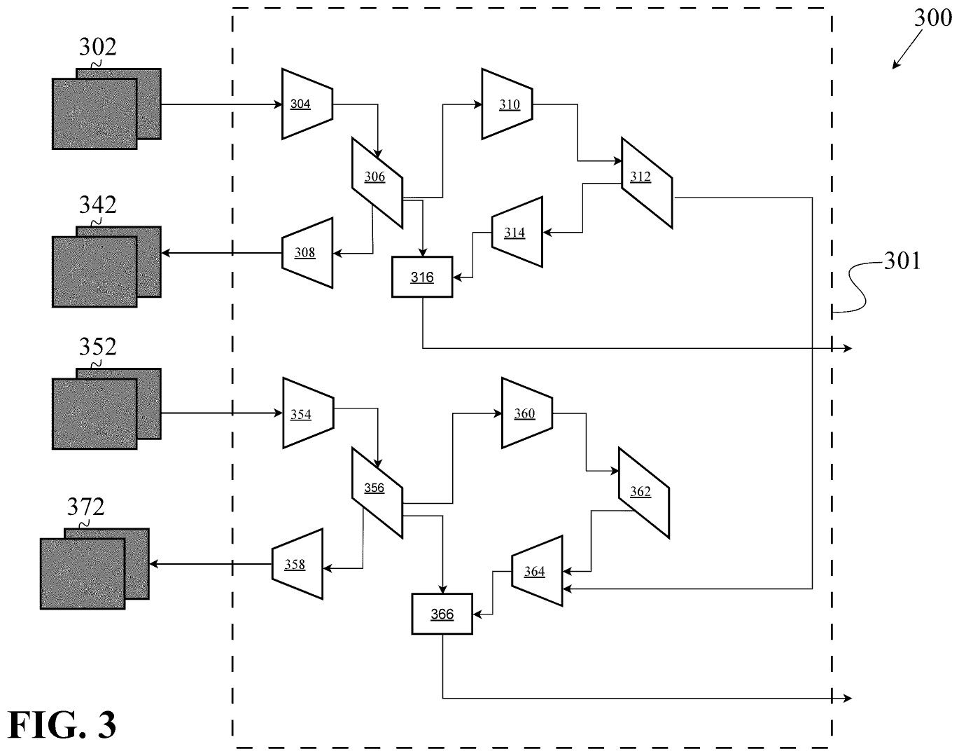

FIG. 3 is a block diagram 300 illustrating details for subband-wise learning-based SAR image compression, according to an embodiment. Block diagram 300 can represent a neural compact representation in which subband images are organized into LF and HF groups. For the LF group, the subbands can be further divided into LF1: {DC, AC1, AC2} and LF2, which includes the remaining AC subbands. Then a learning-based compression can be designed. The learning-based compression can include a latent feature learning block, which is equivalent to a transform, and then a context subsystem that codes context for an Arithmetic Coding (AC) engine.

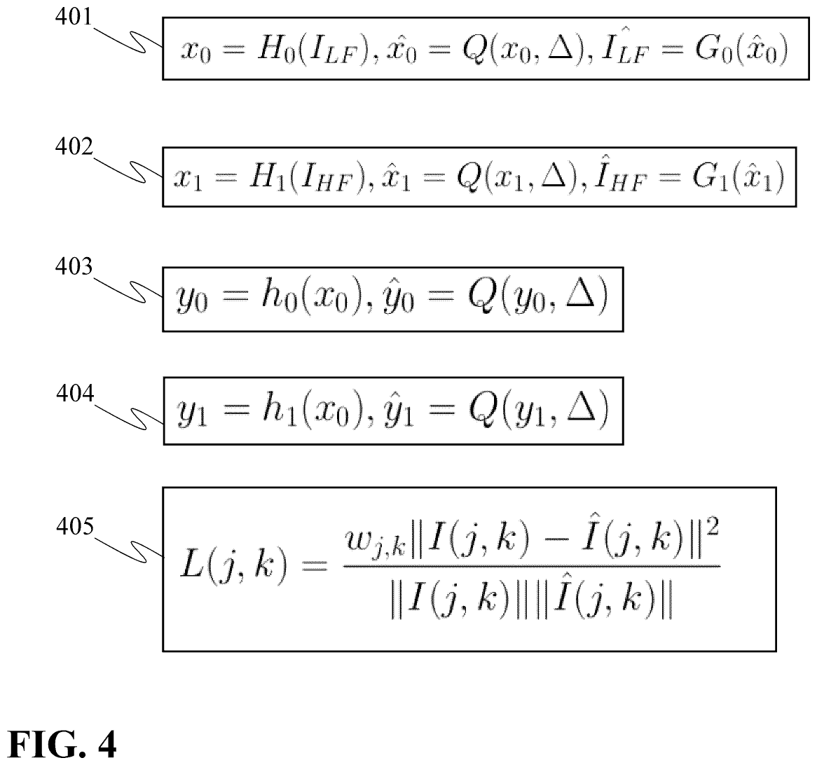

Input LF image components 302 are input to the neural compact representation 301 and is routed to block 304, which performs neural encoding to generate a latent representation, at block 306, at which point the input subbands of k channels of dimension (H/8)×(W/8)×2×k is I_{LF}, the neural encoder will give it a latent representation of x₀ of dimension h×w×N, as indicated in FIG. 4 at 401 and this is quantized and encoded with an arithmetic coder 316. Similarly, Input HF image components 352 are input to the neural compact representation 301 and is routed to block 354, which performs neural encoding to generate a latent representation, at block 356, at which point the input subbands of k channels of dimension (H/8)×(W/8)×2×k is I_{LF}, the neural encoder will give it a latent representation of x₁ of dimension h×w×N, as indicated in FIG. 4 at 402, and this is quantized and encoded with an arithmetic coder 366.

The flow of data continues from block 306 to block 308 which provides a latent feature representation subsystem, which outputs compressed LF image components 342, where the compressed LF image components 342 are compressed versions of input LF image components 302. Similarly, the flow of data continues from block 356 to block 358 which provides a latent feature representation subsystem, which outputs compressed HF image components 372, where the compressed HF image components 372 are compressed versions of input HF image components 352.

Additionally, the output of block 306 is provided to block 310 and arithmetic coder 316. The output of block 310 is routed to block 312, where a context y0 is computed, as indicated in FIG. 4 at 403. The output of block 312 is input to block 314 which in turn provides input to the arithmetic coder 316, which can provide an output that may be stored and/or transmitted. Similarly, the output of block 356 inputs to block 360, which inputs to block 362, where a context y1 is computed, as indicated in FIG. 4 at 404. The output of block 362 is routed to block 364, which inputs to arithmetic coder 366, which can provide an output that may be stored and/or transmitted. At the decoder side, the recovered latent feature will then be decoded back to the reconstructed subband images.

The same basic neural encoding and decoding is designed for the HF band. In one or more embodiments, a loss function L may be used. In embodiments, the loss function L is implemented on a subband basis, and can be regularized with different weighting scheme for amplitude and phase recovery separately. For amplitude recovery, L1 loss on subband images may be used, while for the phase recovery, a loss function that has a different amplitude weighted scheme may be employed in order to achieve optimal performance. Referring to FIG. 4, an exemplary loss function is indicated at 405, in which, (j, k) are indices to a pixel offset and band number in the subband images, and w_{j,k} is the weighting scheme that includes one or more hyperparameters to be optimized.

### Detailed Description of Exemplary Aspects

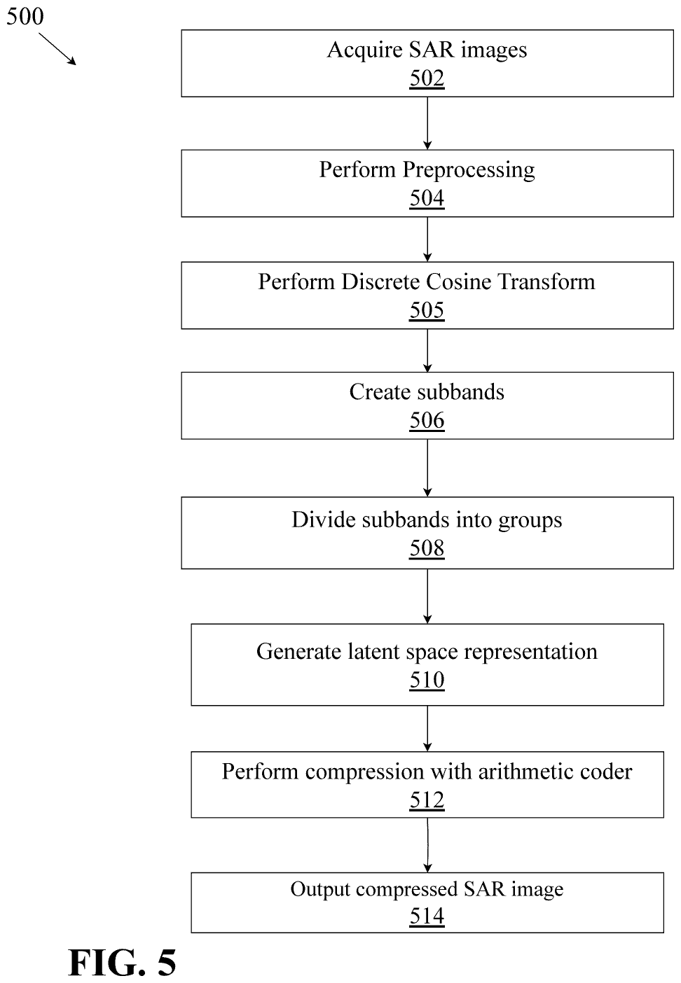

FIG. 5 is a flow diagram illustrating an exemplary method 500 for compressing SAR image data, according to an embodiment. At block 502, SAR images are acquired. In embodiments, the SAR images can be stored in a format that represents pixels as complex numbers. The method 500 continues to block 504, where preprocessing is performed. The preprocessing can include image enhancement, filtering, noise reduction, edge enhancement, region of interest (ROI) identification, and so on. Additionally, the preprocessing can include adding metadata to the image. The metadata can include geographic information, date and/or time information, and/or other relevant information. Thus, in embodiments, the one or more image preprocessing operations includes a radiometric calibration process. In embodiments, the one or more image preprocessing operations includes a geometric calibration process. In embodiments, the one or more image preprocessing operations includes a noise reduction process. In embodiments, the noise reduction process includes a speckle filtering process. In embodiments, the one or more image preprocessing operations includes a region of interest (ROI) extraction process.

The method 500 continues to block 505, where a discrete cosine transform is performed. The discrete cosine transform can include performing a block-wise tokenization scheme. In embodiments, the discrete cosine transform may be performed utilizing a Discrete Cosine Transform Deblur (DCTD) network. The method 500 continues to block 506, where a plurality of subbands is created. The subbands can include a DC component, as well as multiple AC components of varying frequency ranges. The method 500 continues to block 508, where the subband is divided into groups. In embodiments two or more groups may be created, including one or more low frequency (LF) groups, and one or more high frequency (HF) groups. The method 500 continues with generating a latent space representation 510. In one or more embodiments, the latent space representation may be generated by an autoencoder on a subband basis. Embodiments can include discarding one or more subbands prior to generating the latent space representation. Embodiments can include computing a thumbnail version of the latent space representation. In embodiments, the latent space representation can be generated by a variational autoencoder instead of, or in addition to, an autoencoder. Thus, disclosed embodiments can transform raw data that can include complex pixel values of a SAR image into a suitable internal representation or feature vector. The method 500 continues to block 512, where compression is performed with an arithmetic coder. The arithmetic coder can perform compression of latent space representations on a subband basis. The method 500 continues to block 514, where a compressed SAR image is output.

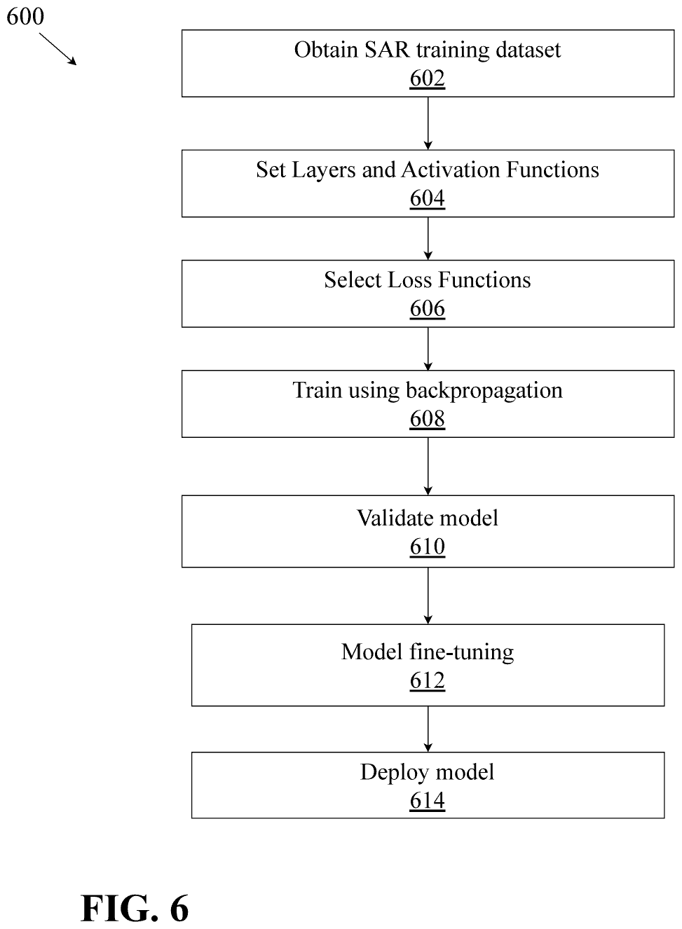

FIG. 6 is a flow diagram illustrating an exemplary method for training a system for compressing and restoring telemetry data, according to an embodiment. The method 600 starts with obtaining a SAR training dataset at block 602. The SAR training dataset can include multiple SAR images acquired under a variety of conditions. The method 600 continues with setting layers and activation functions at block 604. In a neural network, layers are the building blocks that form the structure of the network. Each layer consists of a collection of neurons (also called nodes or units), and each neuron performs a specific computation on the input data. The output of one layer becomes the input to the next layer, creating a series of transformations from the input to the output. The layers can include input layers, output layers, and/or hidden layers. The activation functions introduce non-linearity into the model, allowing it to learn and represent complex patterns in the data. In embodiments, the activation functions can include a sigmoid function, a hyperbolic tangent function, a rectified linear unit (ReLU), a Leaky ReLU, softmax function, and/or other suitable activation function. The method 600 continues to block 606 for selecting loss functions. The loss functions are mathematical functions used in machine learning to measure the difference between the predicted values produced by the model and the actual target values from the training data. In one or more embodiments, the loss functions can include Mean Squared Error (MSE), Mean Absolute Error (MAE), Categorical Cross-Entropy, and/or other suitable loss functions. The loss functions can be used to determine if the model is sufficiently trained. The method 600 continues to block 608 for training the model using backpropagation. The backpropagation process can include computing gradients of the loss with respect to the weights and biases in the output layer. These gradients are propagated backward through the neural network to the hidden layer. The method 600 continues to block 610, where the model is validated. The validation can include using an additional set of SAR images that were not part of the SAR training dataset as a test dataset. The test SAR images can be compressed, reconstructed, and the reconstructed SAR images can be compared with the original SAR test dataset to confirm proper operation of the model. The method 600 can include model fine-tuning at block 612. The model fine-tuning can include adjusting weights and/or other hyperparameters as needed to improve model output. The method 600 continues to block 614, where the model is deployed for use in satellites, aircraft, and/or other sources of SAR images. In this way, disclosed embodiments provide an efficient compression technique for compressing SAR images.

### Temporal-Coherent SAR Compression System Architecture

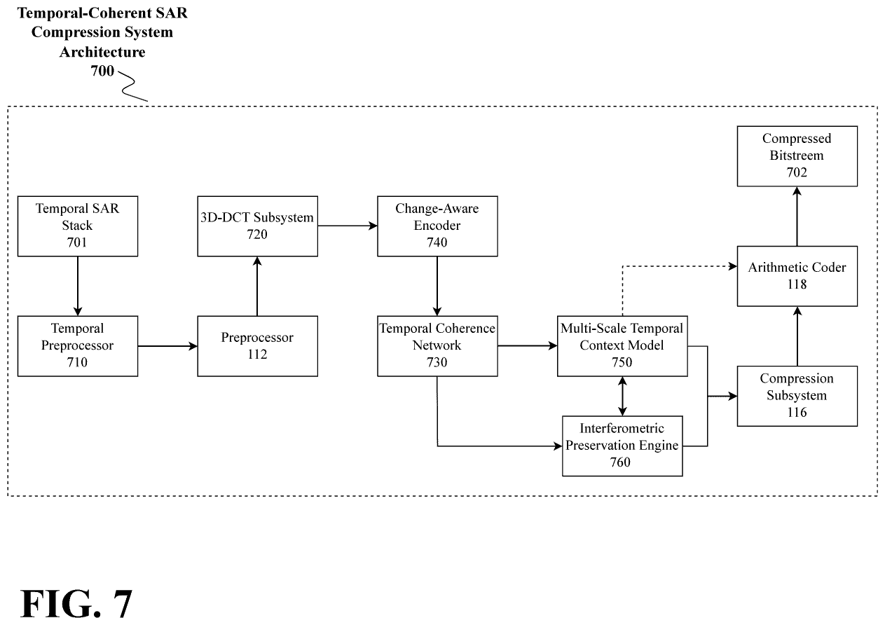

FIG. 7 is a block diagram illustrating exemplary architecture of temporal-coherent SAR compression system 700, in an embodiment. Temporal-coherent SAR compression system 700 receives temporal stack of N synthetic aperture radar images 701, where each image contains in-phase component 720 and quadrature component 721 representing complex-valued SAR data acquired over time. The value of N may range from two images for basic change detection applications to hundreds of images for long-term monitoring scenarios.

Temporal SAR stack preprocessor 710 receives temporal stack 701 and performs initial temporal processing operations. Temporal SAR stack preprocessor 710 includes coregistration subsystem that achieves sub-pixel alignment across all N images in the temporal stack using combination of orbital metadata and image matching techniques. Phase history tracker within temporal SAR stack preprocessor 710 maintains phase continuity across temporal acquisitions by identifying and correcting phase jumps between consecutive frames while preserving consistent phase reference throughout the stack. Temporal radiometric normalizer within temporal SAR stack preprocessor 710 compensates for variations in radar backscatter arising from different acquisition conditions across time, establishing common radiometric reference for subsequent processing.

Output of temporal SAR stack preprocessor 710 flows to image preprocessing subsystem 112, which performs spatial preprocessing operations on each frame. Image preprocessing subsystem 112 applies radiometric calibration, geometric calibration, noise reduction including speckle filtering, and region of interest extraction as needed for each temporal frame.

Enhanced DCT subsystem with temporal extension 720 receives preprocessed temporal stack from image preprocessing subsystem 112. Enhanced DCT subsystem with temporal extension 720 extends two-dimensional discrete cosine transform operations of DCT subsystem 114 into three dimensions by performing DCT across spatial blocks and temporal windows simultaneously. For example, spatial blocks of 8×8 pixels combine with temporal blocks of 4-8 consecutive frames to create three-dimensional processing units. Enhanced DCT subsystem with temporal extension 720 generates temporal-spatial subbands organized into nine hybrid groups formed by combining three spatial subband categories (first low frequency group LF1, second low frequency group LF2, and high frequency group HF) with three temporal subband categories (static subband group TS, slow-change subband group TSC, and fast-change subband group TFC).

Change-aware latent space encoder 740 receives nine hybrid subband groups from enhanced DCT subsystem with temporal extension 720. Reference frame selector within change-aware latent space encoder 740 analyzes temporal stack to identify frames with median temporal characteristics that serve as optimal reference points. Differential encoding branch within change-aware latent space encoder 740 computes and encodes differences between frames and selected references, significantly reducing data volume for slowly changing scene content. Absolute encoding branch within change-aware latent space encoder 740 performs full encoding at keyframe intervals determined by scene change detection or quality degradation monitoring. Adaptive switching logic within change-aware latent space encoder 740 monitors change magnitudes between frames and routes each frame or region to either differential encoding branch or absolute encoding branch based on threshold comparisons.

Temporal coherence network 730 processes latent representations from change-aware latent space encoder 740 to ensure consistency across temporal dimension. Temporal coherence network 730 implements separate processing pathways for amplitude and phase information, recognizing different statistical properties and quality requirements of these components. Bidirectional processing architecture within temporal coherence network 730 includes forward processing networks that capture causal relationships where past frames influence future predictions and backward processing networks that leverage future frames to refine estimates of earlier time points. Cross-attention mechanisms within temporal coherence network 730 enable information exchange between amplitude and phase pathways, allowing each pathway to inform the other for improved compression quality.

Multi-scale temporal context model 750 receives temporally-coherent latent representations from temporal coherence network 730. Frame-level context processing within multi-scale temporal context model 750 examines immediate temporal neighbors to capture short-term variations. Sequence-level context processing considers broader temporal windows to identify periodic patterns such as seasonal variations. Scene-level context processing maintains information about persistent features remaining constant across entire temporal stack. Each scale within multi-scale temporal context model 750 progressively refines context from previous scale, generating comprehensive temporal context for each frame.

Interferometric preservation engine 760 operates in parallel with multi-scale temporal context model 750 to address specific requirements of interferometric SAR applications. Phase unwrapping boundary detector within interferometric preservation engine 760 identifies critical regions where phase differences approach ±π and adjusts quantization parameters to maintain phase continuity. Coherence map generator creates expected coherence maps between frame pairs to guide bit allocation strategies. Baseline-adaptive encoder adjusts compression parameters based on spatial and temporal baselines of potential interferometric pairs within the stack. Atmospheric phase screen separator isolates atmospheric phase effects from ground phase information, enabling independent compression of these components.

Compression subsystem 116 receives outputs from multi-scale temporal context model 750 and interferometric preservation engine 760. Compression subsystem 116 implements differentiated compression strategies based on temporal-spatial subband characteristics, applying compression ratios between 10:1 and 50:1 for static subbands, between 5:1 and 20:1 for slow-change subbands, and between 2:1 and 10:1 for fast-change subbands. Latent feature learning blocks within compression subsystem 116 generate optimized representations for each subband type.

Arithmetic coder subsystem 118 performs final entropy coding of compressed representations from compression subsystem 116. Arithmetic coder subsystem 118 adapts probability models based on temporal context from multi-scale temporal context model 750, maintaining separate probability models for different subband types. Output of arithmetic coder subsystem 118 produces compressed temporal SAR bitstream 702 organized in progressive structure enabling partial decoding from basic change masks through full phase-preserving interferometric data.

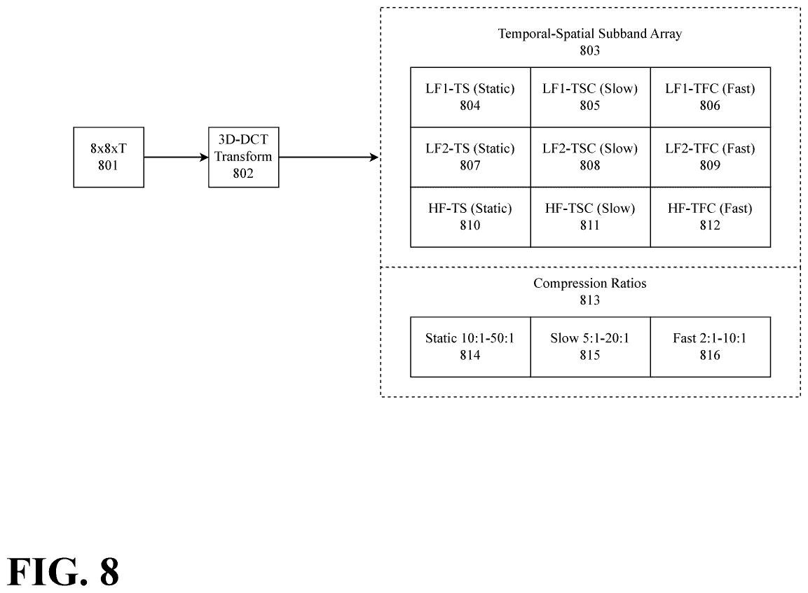

FIG. 8 is a block diagram illustrating temporal-spatial subband decomposition within temporal-coherent SAR compression system 700, in an embodiment. Temporal-spatial block 801 represents input data structure of dimension 8×8×T, where 8×8 denotes spatial block size and T denotes temporal block size typically ranging from 4 to 8 frames. Temporal-spatial block 801 contains co-located pixels from T consecutive frames of temporal stack 701 after preprocessing by temporal SAR stack preprocessor 710 and image preprocessing subsystem 112. LF1 refers to the first low frequency spatial subband group containing the DC and lowest-order AC coefficients (e.g., AC1, AC2). LF2 denotes the second low frequency group comprising mid-frequency spatial components, while HF refers to the high frequency group containing spatial detail and edge-related components. TS (static), TSC (slow-change), and TFC (fast-change) indicate temporal subbands categorized by increasing temporal variability across the stack.

Three-dimensional discrete cosine transform processor 802 receives temporal-spatial block 801 and performs DCT operations across all three dimensions simultaneously. Three-dimensional discrete cosine transform processor 802 extends traditional two-dimensional spatial DCT by incorporating temporal dimension, revealing frequency components that vary across both space and time. Output of three-dimensional discrete cosine transform processor 802 produces coefficients representing different combinations of spatial and temporal frequencies.

Temporal-spatial subband array 803 receives transformed coefficients from three-dimensional discrete cosine transform processor 802 and organizes them into nine distinct hybrid subband groups. Temporal-spatial subband array 803 arranges subbands in three-by-three configuration based on spatial frequency characteristics and temporal variability characteristics.

First row of temporal-spatial subband array 803 contains LF1-TS subband 804, LF1-TSC subband 805, and LF1-TFC subband 806. LF1-TS subband 804 contains DC component and lowest spatial frequency AC components (AC1, AC2) combined with static temporal characteristics, representing unchanging low-frequency spatial features. LF1-TSC subband 805 contains same low spatial frequency components combined with slow-change temporal characteristics, capturing gradual evolution of low-frequency features. LF1-TFC subband 806 contains low spatial frequency components combined with fast-change temporal characteristics, representing rapid modifications in low-frequency content.

Second row of temporal-spatial subband array 803 contains LF2-TS subband 807, LF2-TSC subband 808, and LF2-TFC subband 809. LF2-TS subband 807 contains mid-range spatial frequency components combined with static temporal characteristics. LF2-TSC subband 808 contains mid-range spatial frequencies with slow-change temporal characteristics. LF2-TFC subband 809 contains mid-range spatial frequencies with fast-change temporal characteristics.

Third row of temporal-spatial subband array 803 contains HF-TS subband 810, HF-TSC subband 811, and HF-TFC subband 812. HF-TS subband 810 contains high spatial frequency components combined with static temporal characteristics, typically representing unchanging fine details and edges. HF-TSC subband 811 contains high spatial frequencies with slow-change temporal characteristics. HF-TFC subband 812 contains high spatial frequencies with fast-change temporal characteristics, often corresponding to moving objects or rapidly changing fine details.

Compression ratio selector 813 implements mapping logic or rule-based configuration to apply appropriate quantization and entropy coding strategies to each subband group based on its assigned category (TS, TSC, TFC), ensuring that compression operations maintain phase coherence thresholds defined elsewhere in the system. Static subband compression range 814 specifies compression ratios between 10:1 and 50:1 for all subbands in TS category (804, 807, 810), reflecting high redundancy of unchanging content across temporal dimension. Slow-change subband compression range 815 specifies compression ratios between 5:1 and 20:1 for all subbands in TSC category (805, 808, 811), balancing compression efficiency with preservation of gradual temporal variations. Fast-change subband compression range 816 specifics compression ratios between 2:1 and 10:1 for all subbands in TFC category (806, 809, 812), maintaining higher fidelity for rapidly changing content.

This decomposition allows the system to selectively apply compression strategies tailored to the temporal and spatial dynamics of each subband, maximizing efficiency while preserving critical phase and amplitude information. The hybrid subband structure forms the foundation for downstream adaptive encoding, coherence preservation, and progressive bitstream generation in the temporal-coherent SAR compression pipeline.

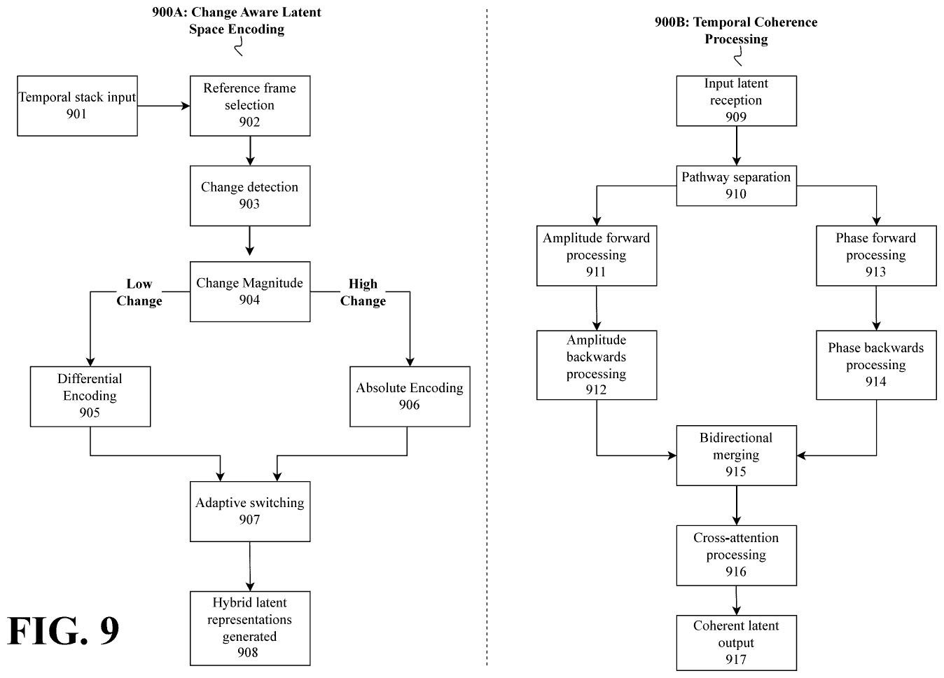

FIG. 9 is a flow diagram illustrating operation of change-aware latent space encoder 740 and temporal coherence network 730 within temporal-coherent SAR compression system 700, in an embodiment. Part A depicts change-aware encoding process that adaptively routes temporal frames through differential or absolute encoding pathways based on detected change magnitudes.

Temporal stack input step 901 provides temporal stack 701 containing N SAR images with in-phase and quadrature components to change-aware latent space encoder 740. Reference frame selection step 902 analyzes temporal characteristics across all frames in temporal stack 701 to identify reference frame having median temporal characteristics that minimizes overall encoding cost. Change detection step 903 computes change magnitude between each frame and selected reference frame by calculating difference metrics in both amplitude and phase domains by computing pixel-wise amplitude deviations and wrapped or unwrapped phase differences.

Change magnitude evaluation step 904 compares computed change magnitude against predetermined threshold to determine appropriate encoding pathway. When change magnitude falls below threshold, differential encoding step 905 encodes only differences between current frame and reference frame, significantly reducing data volume for static or slowly changing content. When change magnitude exceeds threshold, absolute encoding step 906 performs full encoding of current frame as keyframe, ensuring compression errors do not accumulate and providing random access points within compressed stream.

Adaptive switching step 907 routes encoded representations from either differential encoding step 905 or absolute encoding step 906 based on change magnitude evaluation, implementing dynamic selection at multiple granularities from entire frames to localized spatial regions within frames, enabling fine-grained adaptive routing. Hybrid latent generation step 908 combines outputs from both encoding pathways to create unified latent representation maintaining optimal balance between compression efficiency and reconstruction quality.

Part B illustrates temporal coherence processing that ensures consistency across temporal dimension while preserving critical amplitude and phase relationships. Input latent reception step 909 receives hybrid latent representations from change-aware latent space encoder 740. Pathway separation step 910 splits input latents into separate amplitude and phase components, recognizing their different statistical properties and quality requirements.

Amplitude forward processing step 911 processes amplitude information through forward temporal network modeling causal dependencies where prior temporal context informs current frame prediction. Amplitude backward processing step 912 processes amplitude information through backward temporal network using future frames to refine current frame estimates. Phase forward processing step 913 processes phase information through forward temporal network maintaining phase continuity from past frames. Phase backward processing step 914 processes phase information through backward temporal network ensuring phase consistency with future frames.

Bidirectional merging step 915 combines forward and backward processing results for both amplitude and phase pathways, creating bidirectionally-informed representations for each component. Cross-attention processing step 916 implements attention mechanisms between amplitude and phase pathways, allowing each pathway to exchange information and improve overall compression quality through mutual refinement. Coherent latent output step 917 generates final temporally-coherent latent representations that maintain both amplitude fidelity and phase relationships across entire temporal stack for subsequent processing by multi-scale temporal context model 750 and interferometric preservation engine 760.

The combined operation of the change-aware encoder and temporal coherence network produces latent representations optimized for both compression efficiency and interferometric fidelity. These temporally-coherent latents serve as input to subsequent subsystems that perform context modeling, coherence analysis, and final entropy encoding.

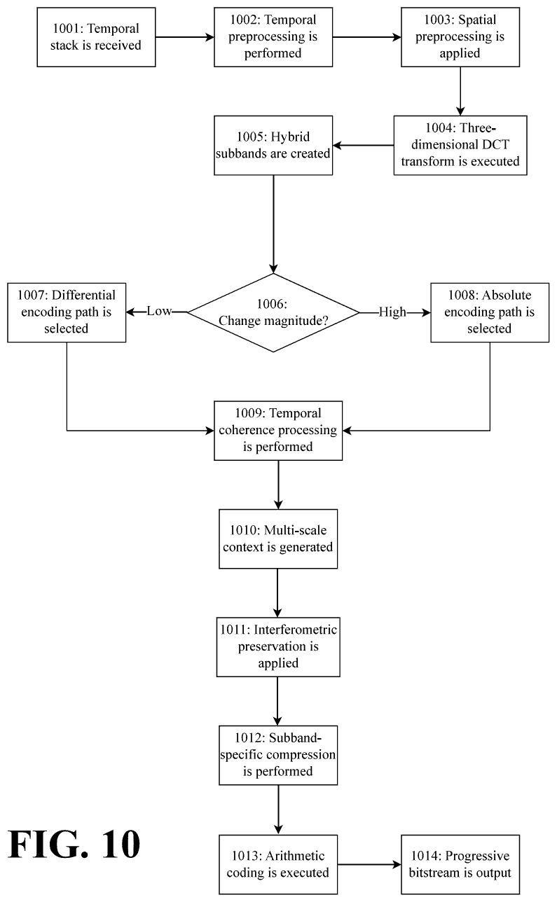

FIG. 10 is a flow diagram illustrating method for temporal-coherent synthetic aperture radar image compression using temporal-coherent SAR compression system 700, in an embodiment. Method begins with receiving temporal stack step 1001 where temporal-coherent SAR compression system 700 receives temporal stack 701 comprising N SAR images, each containing in-phase and quadrature components representing complex-valued radar data in the form [H×W×2×N], where H and W denote spatial dimensions, and N is the number of temporal acquisitions.

Temporal preprocessing step 1002 performs coregistration to achieve sub-pixel alignment across all N images using combination of orbital metadata and image matching techniques, while phase history tracking maintains phase continuity by correcting phase jumps between consecutive acquisitions. Spatial preprocessing step 1003 applies radiometric calibration, geometric calibration, noise reduction, and speckle filtering to each frame according to specifications of image preprocessing subsystem 112.

Three-dimensional DCT transform step 1004 extends two-dimensional discrete cosine transform to temporal dimension by processing spatial blocks of 8×8 pixels combined with temporal blocks of 4-8 consecutive frames simultaneously. Hybrid subband creation step 1005 organizes DCT coefficients into nine hybrid subband groups by combining three spatial frequency categories LF1, LF2, and HF with three temporal variability categories TS, TSC, and TFC.

Change detection decision step 1006 evaluates change magnitude between current frame and reference frame selected for its median temporal characteristics. When change magnitude falls below predetermined threshold, differential encoding path step 1007 encodes only differences from reference frame, achieving high compression for static or slowly changing content. When change magnitude exceeds threshold, absolute encoding path step 1008 performs full encoding of current frame as keyframe to prevent error accumulation and provide random access points.

Latent representations from both encoding paths are input to temporal coherence processing step 1009, where bidirectional temporal networks process amplitude and phase information through separate pathways connected by cross-attention mechanisms. Multi-scale context generation step 1010 hierarchically processes frame-level, sequence-level, and scene-level contexts, with each scale progressively refining context from previous scale.

Interferometric preservation step 1011 identifies phase unwrapping boundaries and adjusts quantization parameters to maintain phase continuity while generating coherence maps to guide bit allocation based on expected interferometric processing requirements. Subband-specific compression step 1012 applies differentiated compression strategies with ratios between 10:1 and 50:1 for static subbands, between 5:1 and 20:1 for slow-change subbands, and between 2:1 and 10:1 for fast-change subbands.

Arithmetic coding step 1013 performs entropy coding using probability models adapted based on temporal context, maintaining separate models for different subband types to optimize compression efficiency. Progressive bitstream output step 1014 generates compressed temporal SAR bitstream 750 organized in four progressive levels allowing partial decoding from basic change masks at level one through change magnitudes at level two, full amplitude reconstruction at level three, and phase-preserving interferometric data at level four. This enables applications to selectively decode only the information required for their analysis task, such as change detection or full interferometric reconstruction.

This method enables efficient compression of temporal SAR image stacks while maintaining the amplitude and phase integrity necessary for advanced interferometric analysis, environmental monitoring, and change detection applications.

### Exemplary Computing Environment

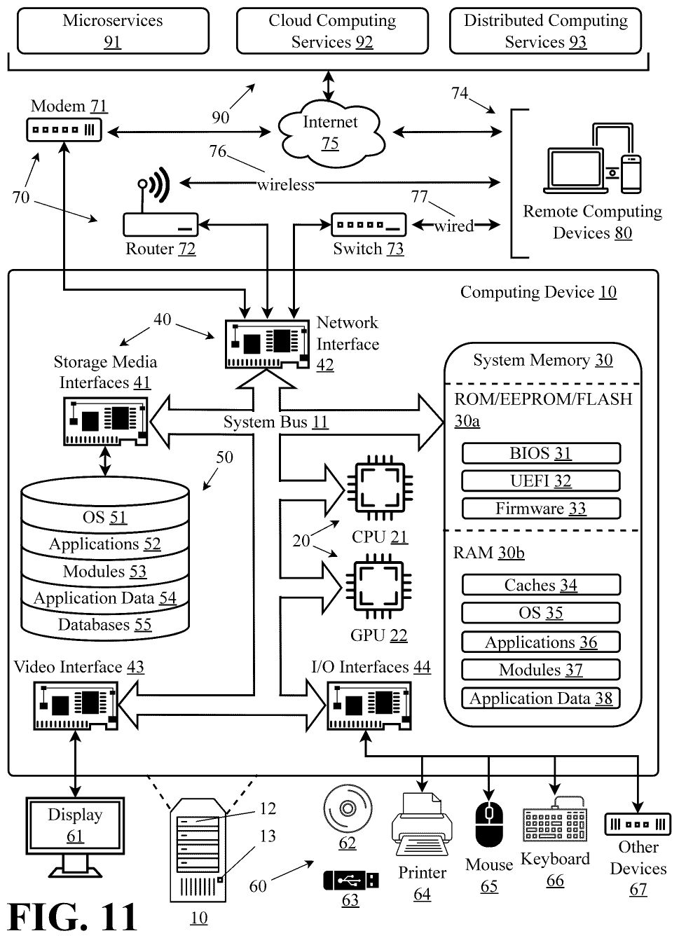

FIG. 11 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid-state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program subsystems 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program subsystems 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containers or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

As can now be appreciated, disclosed embodiments provide improvements in data compression for SAR images. Disclosed embodiments provide a subband learning-based compression solution for SAR image compression, which has a divide-and-conquer strategy in dealing with redundancy in images by having a neural network encoder of latent representation, followed by a multi-stage context model that drives an arithmetic coding engine. This enables compressing of SAR images to reduce their file size, allowing for more efficient use of storage resources. Additionally, the compressed SAR images require less bandwidth for transmission, making it faster to send and receive data over networks, including satellite links and the internet. Thus, disclosed embodiments enable SAR images to be transmitted more efficiently, promoting important applications such as environmental monitoring, reconnaissance, surveillance, meteorology, and others.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
receive a temporal stack of N synthetic aperture radar (SAR) images, wherein each SAR image in the temporal stack comprises an in-phase component and a quadrature component;
perform temporal preprocessing on the temporal stack, including coregistration to achieve sub-pixel alignment across the N SAR images and phase history tracking to maintain phase continuity across temporal acquisitions;
perform a three-dimensional discrete cosine transform (3D-DCT) operation across spatial and temporal dimensions of the temporal stack to create a plurality of temporal-spatial subbands, wherein the temporal-spatial subbands are organized into hybrid groups comprising:
spatial subband groups including a first low frequency group, a second low frequency group, and a high frequency group; and
temporal subband groups including a static subband group, a slow-change subband group, and a fast-change subband group;
implement a change-aware latent space encoder comprising:
a reference frame selector that identifies a reference frame having median temporal characteristics from the temporal stack;
a differential encoding branch that encodes temporal changes relative to the reference frame; and
an absolute encoding branch that performs full encoding at keyframe intervals determined by at least one of scene change detection or quality degradation monitoring;
generate temporally-coherent latent space representations for the hybrid groups of temporal-spatial subbands using a temporal coherence network that processes amplitude and phase information through separate pathways with cross-attention mechanisms; and
perform arithmetic coding on the temporally-coherent latent space representations to create a compressed bitstream, wherein the compressed bitstream preserves interferometric coherence properties across the temporal stack.

2. The computer system of claim 1, wherein the software instructions further implement an interferometric preservation engine that identifies phase unwrapping boundaries in the temporal stack and adjusts quantization parameters near the phase unwrapping boundaries to preserve interferometric properties.

3. The computer system of claim 1, wherein the software instructions further implement a multi-scale temporal context model that hierarchically processes frame-level context, sequence-level context, and scene-level context, with each scale progressively refining the context from the previous scale.

4. The computer system of claim 1, wherein the software instructions apply compression ratios between 10:1 and 50:1 for the static subband group, between 5:1 and 20:1 for the slow-change subband group, and between 2:1 and 10:1 for the fast-change subband group.

5. The computer system of claim 1, wherein the temporal coherence network implements a coherence loss function interferometric that jointly optimizes amplitude consistency, phase relationships, and interferometric coherence between frame pairs.

6. The computer system of claim 1, wherein the change-aware latent space encoder monitors change magnitude between frames and adaptively routes frames to either the differential encoding branch or the absolute encoding branch based on whether the change magnitude exceeds a predetermined threshold.

7. The computer system of claim 1, wherein the software instructions generate a progressive bitstream structure enabling partial decoding from change masks at a first level through full phase-preserving interferometric data at a fourth level.

8. The computer system of claim 1, wherein the temporal preprocessing comprises a temporal radiometric normalizer that compensates for varying acquisition conditions across the temporal stack to establish a common radiometric reference.

9. The computer system of claim 1, wherein the temporal coherence network comprises bidirectional temporal processing networks with separate pathways for amplitude and phase information connected through cross-attention mechanisms.

10. The computer system of claim 2, wherein the interferometric preservation engine separates atmospheric phase effects from ground phase information to enable independent compression of atmospheric and ground-based phase components.

11. A method for temporal-coherent synthetic aperture radar image compression, comprising:
receiving a temporal stack of N synthetic aperture radar (SAR) images, wherein each SAR image in the temporal stack comprises an in-phase component and a quadrature component;
performing temporal preprocessing on the temporal stack, including coregistration to achieve sub-pixel alignment across the N SAR images and phase history tracking to maintain phase continuity across temporal acquisitions;
performing a three-dimensional discrete cosine transform (3D-DCT) operation across spatial and temporal dimensions of the temporal stack to create a plurality of temporal-spatial subbands, wherein the temporal-spatial subbands are organized into hybrid groups comprising:
spatial subband groups including a first low frequency group, a second low frequency group, and a high frequency group; and
temporal subband groups including a static subband group, a slow-change subband group, and a fast-change subband group;
implementing a change-aware latent space encoder comprising:
a reference frame selector that identifies a reference frame having median temporal characteristics from the temporal stack;
a differential encoding branch that encodes temporal changes relative to the reference frame; and
an absolute encoding branch that performs full encoding at keyframe intervals determined by at least one of scene change detection or quality degradation monitoring;
generating temporally-coherent latent space representations for the hybrid groups of temporal-spatial subbands using a temporal coherence network that processes amplitude and phase information through separate pathways with cross-attention mechanisms; and
performing arithmetic coding on the temporally-coherent latent space representations to create a compressed bitstream, wherein the compressed bitstream preserves interferometric coherence properties across the temporal stack.

12. The method of claim 11, further comprising implementing an interferometric preservation engine that identifies phase unwrapping boundaries in the temporal stack and adjusts quantization parameters near the phase unwrapping boundaries to preserve interferometric properties.

13. The method of claim 11, further comprising implementing a multi-scale temporal context model that hierarchically processes frame-level context, sequence-level context, and scene-level context, with each scale progressively refining the context from the previous scale.

14. The method of claim 11, further comprising applying compression ratios between 10:1 and 50:1 for the static subband group, between 5:1 and 20:1 for the slow-change subband group, and between 2:1 and 10:1 for the fast-change subband group.

15. The method of claim 11, wherein the temporal coherence network implements a coherence loss function that jointly optimizes amplitude consistency, phase relationships, and interferometric coherence between frame pairs.

16. The method of claim 11, wherein the change-aware latent space encoder monitors change magnitude between frames and adaptively routes frames to either the differential encoding branch or the absolute encoding branch based on whether the change magnitude exceeds a predetermined threshold.

17. The method of claim 11, further comprising generating a progressive bitstream structure enabling partial decoding from change masks at a first level through full phase-preserving interferometric data at a fourth level.

18. The method of claim 11, wherein the temporal preprocessing comprises a temporal radiometric normalizer that compensates for varying acquisition conditions across the temporal stack to establish a common radiometric reference.

19. The method of claim 11, wherein the temporal coherence network comprises bidirectional temporal processing networks with separate pathways for amplitude and phase information connected through cross-attention mechanisms.

20. The method of claim 12, wherein the interferometric preservation engine separates atmospheric phase effects from ground phase information to enable independent compression of atmospheric and ground-based phase components.
